(19) United States
(12) Patent Application Publication
(10) Pub. No.: US 2018/0290350 A1
(43) Pub. Date: Oct. 11, 2018

(54) METHOD FOR PRODUCING FOAMED MOLDED ARTICLE WITH INTEGRATED SURFACE SKIN

(71) Applicants: TACHI-S CO., LTD., Tokyo (JP); SANYO CHEMICAL INDUSTRIES, LTD., Kyoto (JP)

(72) Inventors: Tsuyoshi TABATA, Tokyo (JP); Yoshiaki KATAYAMA, Tokyo (JP); Takahiro ISHIDA, Kyoto (JP)

(21) Appl. No.: 15/577,985

(22) PCT Filed: May 20, 2016
(86) PCT No.: PCT/JP2016/065067

§ 371 Date: Nov. 29, 2017

(30) Foreign Application Priority Data
May 29, 2015 (JP) 2015-109811

(51) Int. Cl. B29C 44/42; B29C 44/14

(52) U.S. Cl. CPC B29C 44/425; B29C 44/14; B29L 2031/3023; B29K 2995/0068; B29K 2713/00

(57) ABSTRACT

Provided is a method of producing a foamed article molded integrally with a surface cover in which a plurality of stock solutions of a foam resin are injected into a bag-shaped surface cover (11), and a core body (12) made of a foam resin is molded integrally with the surface cover (11). A discharge port of a nozzle (20) through which the plurality of stock solutions are injected into the surface cover (11) is covered with a mesh body (14), and the plurality of stock solutions are injected into the surface cover (11) through the mesh body (14).

### TECHNICAL FIELD

The present invention relates to a method of producing a foamed article molded integrally with a surface cover.

### BACKGROUND ART

For example, a headrest of a vehicle seat is produced in such a manner that a foam resin stock solution is injected into a surface cover set inside a molding die, the foam resin stock solution is allowed to react in the surface cover, so as to mold a core body made of a foam resin integrally with the surface cover. A surface cover of a three-layer structure is widely used as the surface cover in which a surface material such as a fabric, wadding such as a urethane slab, and a film such as a urethane film are stacked. However, a surface cover of a bilayer structure is also used in which a film is not provided.

The film such as a urethane film which forms the inner surface of the surface cover prevents that the foam resin stock solution permeates the wadding or the surface material. In the production of a foamed article molded integrally with a surface cover which uses the surface cover of the bilayer structure (the surface material and the wadding) in which the film is not provided, a dispersion which catches the foam resin stock solution discharged from a nozzle is provided inside the surface cover, and the flow of the foam resin stock solution is weakened by the dispersion to suppress the permeation of the foam resin stock solution with respect to the surface material and the wadding (see Patent Documents 1 to 3).

### RELATED ART REFERENCE

### PATENT DOCUMENT

Patent Document 1: Japanese Unexamined Patent Application Publication No. 11-313728

Patent Document 2: Japanese Unexamined Patent Application Publication No. 8-164034

Patent Document 3: Japanese Unexamined Patent Application Publication No. 6-312425

### SUMMARY OF THE INVENTION

### Problems to be Solved by the Invention

When the surface cover is formed as a monolayer structure having only a surface material to be simplified, the production cost of the foamed article molded integrally with the surface cover can be reduced. However, although the dispersion in the producing method described in Patent Documents 1 to 3 is used, there is a risk that the foam resin stock solution permeates a surface material formed of cloth such as a fabric having liquid permeability, and the permeated foam resin stock solution is solidified, resulting in deterioration the texture of the surface cover.

In consideration of the fact that the discharging pressure of the foam resin stock solution in the surface cover having a bilayer structure of a surface material and wadding is typically 12 MPa to 18 MPa, the discharging pressure of the foam resin stock solution is reduced, and the flow of the injected foam resin stock solution is weakened. Thus, it can be suppressed that the foam resin stock solution permeates the surface cover which has a monolayer structure including only a surface material.

However, in a case where a plurality of stock solutions are mixed and reacted inside the surface cover, such as a two-liquid foam resin and the like, there is a risk that the discharging pressure is low so that the plurality of stock solutions are not mixed sufficiently and the reaction does not proceed, and the volume of the core body is not sufficient.

The invention has been made in consideration of the above situation, and an object thereof is to provide a method of producing a foamed article molded integrally with a surface cover in which even in a relatively thin surface cover such as a monolayer structure having only a surface material, the permeation of the foam resin stock solution can be suppressed, and the foam resin can be molded stably.

### Means for Solving the Problems

In a method of producing a foamed article molded integrally with a surface cover of an aspect of the invention, a plurality of stock solutions in a foam resin are injected into a bag-shaped surface cover, and a core body made of a foam resin is molded integrally with the surface cover. A discharge port of a nozzle through which the plurality of stock solutions are injected into the surface cover is covered with a mesh body, and the plurality of stock solutions are injected into the surface cover through the mesh body.

### Advantages of the Invention

According to the invention, even in relatively thin surface cover, the permeation of the foam resin stock solution can be suppressed, and the foam resin can be molded stably.

### BRIEF DESCRIPTION OF THE DRAWINGS

FIG. 1 is a perspective view illustrating one example of a foamed article molded integrally with a surface cover for explaining an embodiment of the invention.

FIG. 2 is a sectional view illustrating the foamed article molded integrally with the surface cover of FIG. 1.

FIG. 3 is a view illustrating a method of producing the foamed article molded integrally with the surface cover of FIG. 1.

FIG. 4 is a view illustrating a process subsequent to FIG. 3 in the method of producing the foamed article molded integrally with the surface cover of FIG. 1.

FIG. 5 is a view illustrating a process subsequent to FIG. 4 in the method of producing the foamed article molded integrally with the surface cover of FIG. 1.

FIG. 6 is a schematic view of a foam resin injector connected to a nozzle.

FIG. 7 is a sectional view of one example of a mesh body which covers a discharge port of the nozzle.

FIG. 8 is a schematic view illustrating a state of a plurality of stock solutions of a foam resin when passing through the mesh body of FIG. 7.

FIG. 9 is an appearance view of a modification of the mesh body of FIG. 7.

### MODES FOR CARRYING OUT THE INVENTION

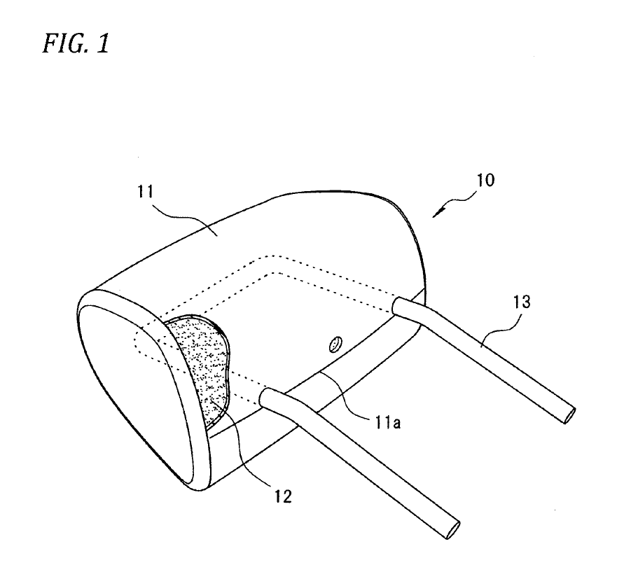

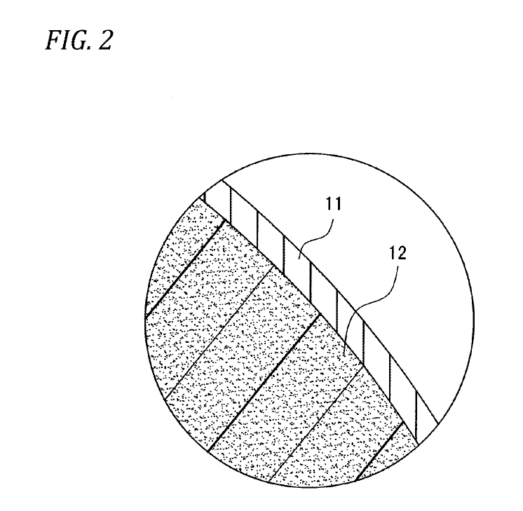

FIG. 1 illustrates one example of a foamed article molded integrally with a surface cover for explaining an embodiment of the invention, and FIG. 2 illustrates a cross section of the foamed article molded integrally with the surface cover of FIG. 1.

The foamed article molded integrally with the surface cover illustrated in FIG. 1 is a headrest 10 of the vehicle seat. The headrest 10 includes a surface cover 11 configuring a headrest cover, a core body 12 which is filled in the surface cover 11, and a metal frame 13 which is embedded into the core body 12 and in which a pair of leg parts are exposed outside the surface cover 11.

The surface cover 11 is a monolayer structure of a surface material foiled of cloth such as a fabric having liquid permeability. The surface cover 11 is configured in such a manner that the surface material is sewn in a bag shape and is turned upside down at an overturn port 11a such that an outlet seam is on inside, and the overturn port 11a is sewn up. The core body 12 is made of a relatively soft foam resin such as foamed polyurethane and is foamed inside the surface cover 11 to be molded integrally with the surface cover 11.

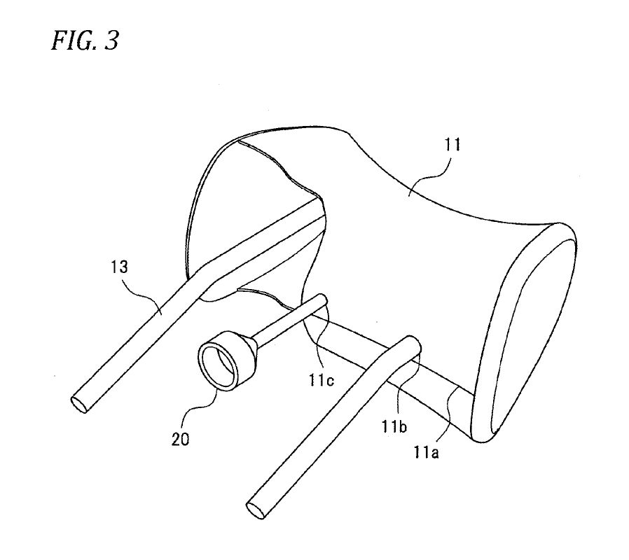

FIGS. 3 to 5 illustrate one example of a producing method of the headrest 10.

First, as illustrated in FIG. 3, the leg part of the frame 13 is inserted into a through hole 11b of the bag-shaped surface cover 11, the frame 13 is mounted in the surface cover 11, and an injection nozzle 20 of the stock solution of the foam resin is mounted in a nozzle insertion port 11c of the surface cover 11.

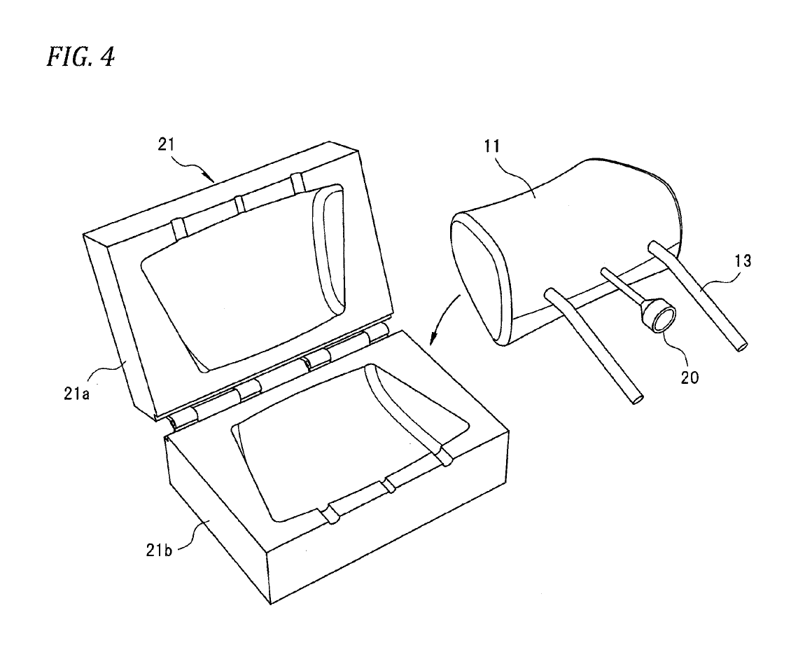

Next, as illustrated in FIG. 4, the surface cover 11 in which the frame 13 and the injection nozzle 20 are mounted is loaded in a cavity of an integral foam molding die 21 configured by an upper die 21a and a lower die 21b.

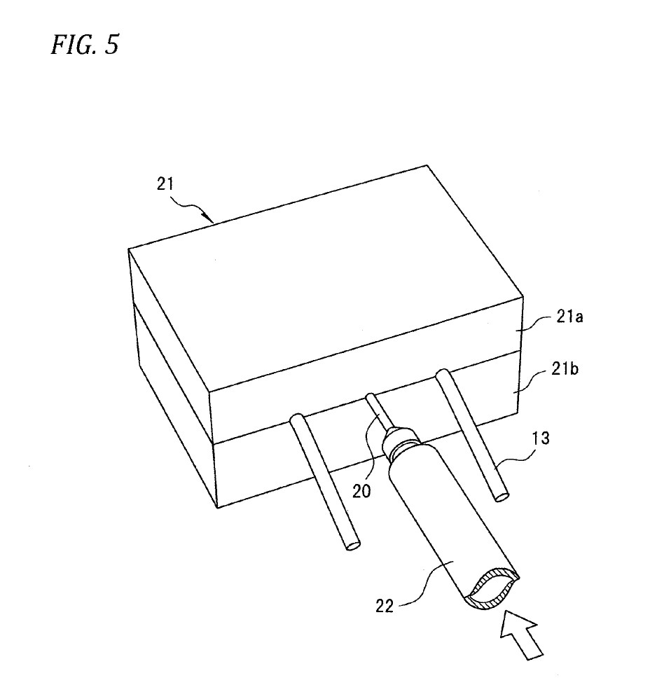

As illustrated in FIG. 5, a head part of an injector 22 which supplies the stock solution of the foam resin is connected in the injection nozzle 20, the stock solution of the foam resin is injected into the surface cover 11 through the injection nozzle 20, and the stock solution of the foam resin is foamed inside the surface cover 11 to mold the core body 12.

After the core body 12 is molded completely, the surface cover 11, the core body 12, and the frame 13 are removed from the integral foam molding die 21, and the injection nozzle 20 is detached from the nozzle insertion port 11c, thereby obtaining the headrest 10.

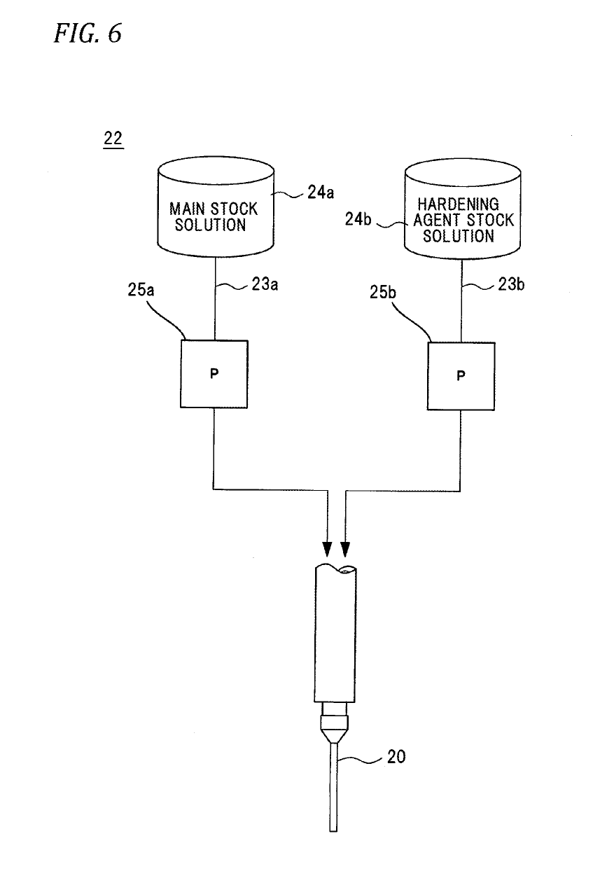

FIG. 6 illustrates a configuration of one example of the injector 22. Incidentally, in an example illustrated in FIG. 6, the description will be given by using foamed polyurethane as the foam resin forming the core body 12.

Typically, the foamed polyurethane is foamed by mixing a main stock solution having; a polyol as a main component and a hardening agent stock solution having a polyisocyanate as a main component. The injector 22 includes a main stock solution tank 24a which stores the main stock solution and a hardening agent stock solution tank 24b which stores the hardening agent stock solution.

The main stock solution stored in the main stock solution tank 24a is supplied to the head part of the injector 22 through a pipe 23a and a pump 25a. The hardening agent stock solution stored in the hardening agent stock solution tank 24b is supplied to the head part of the injector 22 through the pipe 23b and the pump 25b. The main stock solution and the hardening agent stock solution are discharged from a discharge port of the injection nozzle 20 connected in the head part of the injector 22 at a predetermined compounding ratio and a predetermined discharging pressure, and are injected inside the bag-shaped surface cover 11.

In the inside of the surface cover 11, an urethanization reaction proceeds between the polyol contained in the main stock solution and the polyisocyanate contained in the hardening agent stock solution. In addition, moisture contained in the main stock solution and the polyisocyanate react to generate carbon dioxide gas, and the core body 12 made of foamed polyurethane is molded.

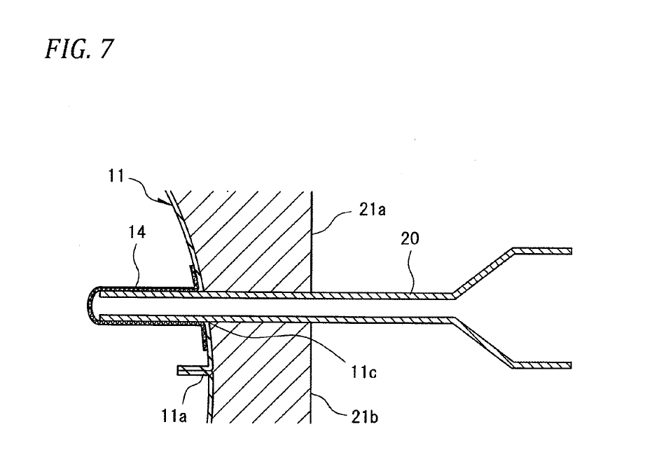

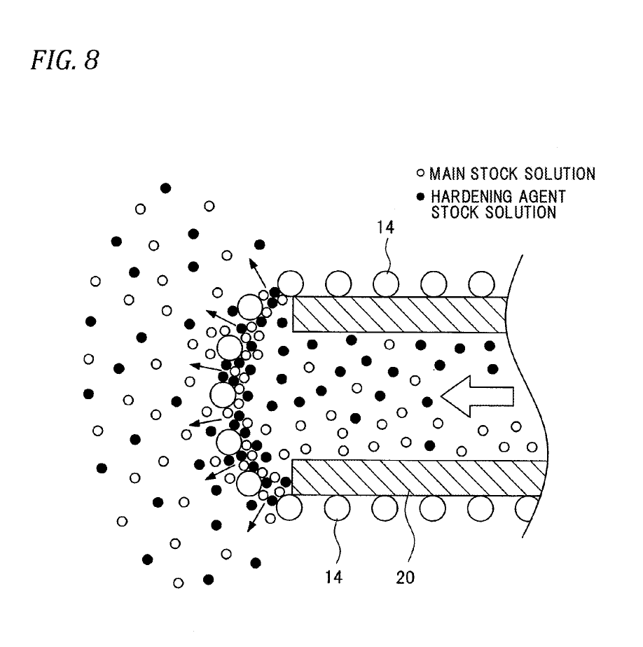

FIG. 7 illustrates one example of a mesh body which covers the discharge port of the injection nozzle 20. FIG. 8 illustrates a state of a plurality of stock solutions of the foam resin when passing through the mesh body of FIG. 7.

In the headrest 10 of this example, the surface cover 11 has a monolayer structure of cloth such as a fabric having liquid permeability. The discharging pressure of the stock solution from the injection nozzle 20 is set to be low to suppress the permeation of the main stock solution and the hardening agent stock solution into the surface cover 11.

As described above, the discharging pressure of the stock solution in a case where the surface cover has a bilayer structure of the surface material and the wadding is typically in a range of 12 MPa to 18 MPa. Meanwhile, in this example in which the surface cover 11 has a monolayer structure of cloth having liquid permeability, the discharging pressure of the stock solution is in a range of 8 MPa to 10 MPa, for example.

The bag-shaped mesh body 14 configured as a cover of the injection nozzle 20 is provided in the nozzle insertion port 11c of the surface cover 11, so as to compensate insufficient mixing of the main stock solution and the hardening agent stock solution resulting from the decrease of the discharging pressure.

The mesh body 14 is formed by sewing mesh cloth made of slab urethane and the like in a bottomed cylindrical shape. The edge part of the opening end of the mesh body 14 is sewn or bonded in the nozzle insertion port 11c of the surface cover 11 to be integrated with the surface cover 11. In a state where the protruding port of the tip of the injection nozzle 20 closely contacts the bottom of the bottomed cylindrical mesh body 14, the injection nozzle 20 is inserted into the nozzle insertion port 11c of the surface cover 11, and the discharge port of the injection nozzle 20 is covered by the mesh body 14.

The main stock solution and the hardening agent stock solution discharged from the injection nozzle 20 are injected into the surface cover 11 through the mesh of the mesh body 14 covering the discharge port, and collide and are agitated when passing through the mesh of the mesh body 14. Accordingly, the mixing of the main stock solution and the hardening agent stock solution is promoted, and foam reaction is promoted although the discharging pressure of the main stock solution and the hardening agent stock solution is reduced, whereby the core body 12 can be molded stably. Further, the discharging pressure of the main stock solution and the hardening agent stock solution is reduced to suppress the permeation of the main stock solution and the hardening agent stock solution into the surface cover 11 and to suppress the deterioration of the texture of the surface cover 11.

The mesh-shaped cloth forming the mesh body 14 preferably has such air permeability that the main stock solution and the hardening agent stock solution can pass therethrough without stagnation, and preferably has at least 100 cm³/cm²/s of air permeability although varying depending on the viscosity of the main stock solution or the hardening agent stock solution. Incidentally, the air permeability is a value measured by an air permeability test method prescribed in JISL1096. The contents of JISL1096 are incorporated hereinto by reference.

When the air permeability of the mesh body 14 is excessive, the agitating effect obtained when the main stock solution and the hardening agent stock solution pass through the mesh body 14 is weakened. Thus, the mesh-shaped cloth forming the mesh body 14 preferably has at most 1000 cm³/cm³ /s of the air permeability.

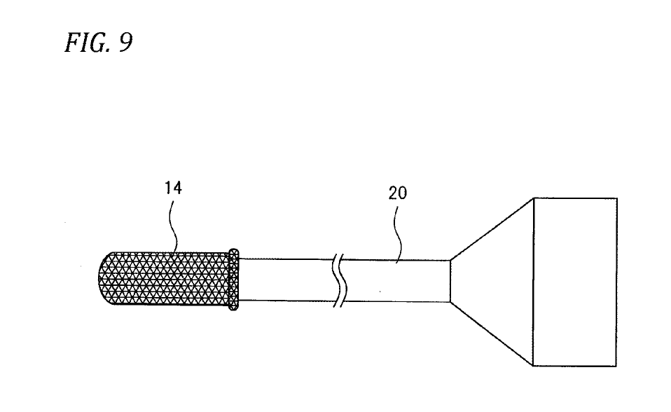

FIG. 9 illustrates a modification of the mesh body 14 illustrated in FIG. 7.

In an example illustrated in FIG. 9, the mesh body 14 is configured as a cap fixed in the tip part of the injection nozzle 20. That is, the mesh body 14 in which the mesh cloth is sewn in a bottomed cylindrical shape is prepared separately from the surface cover 11. The mesh body 14 is fixed in the tip part of the injection nozzle 20, and the discharge port of the injection nozzle 20 is covered with the mesh body 14. In that state, the injection nozzle 20 may be inserted into the nozzle insertion port 11c of the surface cover 11.

Even in that case, the main stock solution and the hardening agent stock solution discharged from the injection nozzle 20 are injected into the surface cover 11 through the mesh of the mesh body 14 covering the discharge port, and collide and are agitated when passing through the mesh of the mesh body 14 so as to promote the mixing of the main stock solution and the hardening agent stock solution.

In the above description, the surface cover 11 has a monolayer structure of cloth (surface material) having liquid permeability. However, the invention may be applied to a case where the surface cover has a bilayer structure of a surface material and wadding. The mixing of the plurality of stock solutions of the foam resin forming the core body 12 is promoted to stably mold the core body 12, and the permeation of the stock solution into the surface cover is suppressed to suppress the deterioration of the texture of the surface cover.

### INDUSTRIAL APPLICABILITY

The description has been given by using the headrest 10 as an example. However, the invention may be applied to another foamed article molded integrally with a surface cover such as an armrest or a sheet tray.

The present application is based on Japanese Patent Application (No. 2015-109811) filed on May 29, 2015. The contents thereof are incorporated hereinto by reference.

### DESCRIPTION OF REFERENCE NUMERALS AND SIGNS

10: headrest

11: surface cover

12: core body

13: frame

14: mesh body

20: injection nozzle

21: integral foam molding die

22: injector

24a: main stock solution tank

24b: hardening agent stock solution tank

1. A method of producing a foamed article molded integrally with a surface cover in which a plurality of stock solutions of a foam resin are injected into a bag-shaped surface cover, and a core body made of a foam resin is molded integrally with the surface cover, wherein
a discharge port of a nozzle through which the plurality of stock solutions are injected into the surface cover is covered with a mesh body, and the plurality of stock solutions are injected into the surface cover through the mesh body.

2. The method of producing the foamed article molded integrally with the surface cover according to claim 1, wherein
the mesh body is provided integrally with the surface cover in a nozzle insertion port of the surface cover in a bottomed cylindrical shape, and is configured as a cover which houses a tip part of the nozzle.

3. The method of producing the foamed article molded integrally with the surface cover according to claim 1, wherein
the mesh body is configured as a cap fixed in a tip part of the nozzle.

4. The method of producing the foamed article molded integrally with the surface cover according to claim 1, wherein
the mesh body has air permeability in a range from 100 cm³/cm²/s to 1000 cm³/cm²/s.

5. The method of producing the foamed article molded integrally with the surface cover according to claim 1, wherein
a discharging pressure of the plurality of stock solutions is in a range from 8 MPa to 10 MPa.

6. The method of producing the foamed article molded integrally with the surface cover according to claim 1, wherein
the surface cover has a monolayer structure of cloth having liquid permeability.
